(19) United States
(12) Patent Application Publication
(10) Pub. No.: US 2004/0096769 A1
(43) Pub. Date: May 20, 2004

(54) Radiographic film with improved signal detection for mammography

(75) Inventors: Anthony Adin, Rochester, NY (US); Richard E. Beal, Ontario, NY (US); Robert E. Dickerson, Hamlin, NY (US); Anthony D. Gingello, Rochester, NY (US)

Correspondence Address: Paul A. Leipold, Patent Legal Staff, Eastman Kodak Company, 343 State Sreet, Rochester, NY, 14650-2201, US

(73) Assignee: Eastman Kodak Company

(21) Appl. No.: 10/440,750

(22) Filed: May 19, 2003

Related U.S. Application Data
(63) Continuation-in-part of application No. 10/299,936, filed on Nov. 19, 2002, now abandoned.

(51) Int. Cl. G03C 1/035; G03C 1/46; G03C 5/16; G03C 1/825; G03C 5/17

(52) U.S. Cl. 430/139; 430/509; 430/512; 430/523; 430/567; 430/966; 430/967

(57) ABSTRACT

A radiographic silver halide film is designed for improved imaging of dense soft tissue as in mammography. The film includes a silver halide emulsion on each side of the support and at least one silver halide emulsion contains cubic silver halide grains that are doped with a metal hexacoordination complex compound such as a ruthenium hexacoordination complex compound.

### RELATED APPLICATION

This is a Continuation-in-part of U.S. Ser. No. 10/299,936 filed Nov. 19, 2002 by Adin, Beal, Dickerson, and Gingello.

### FIELD OF THE INVENTION

This invention is directed to radiography. In particular, it is directed to a radiographic silver halide film that provides improved medical diagnostic images of dense soft tissues such as in mammography.

### BACKGROUND OF THE INVENTION

The use of radiation-sensitive silver halide emulsions for medical diagnostic imaging can be traced to Roentgen's discovery of X-radiation by the inadvertent exposure of a silver halide film. Eastman Kodak Company then introduced its first product specifically that was intended to be exposed by X-radiation in 1913.

In conventional medical diagnostic imaging the object is to obtain an image of a patient's internal anatomy with as little X-radiation exposure as possible. The fastest imaging speeds are realized by mounting a dual-coated radiographic element between a pair of fluorescent intensifying screens for imagewise exposure. About 5% or less of the exposing X-radiation passing through the patient is adsorbed directly by the latent image forming silver halide emulsion layers within the dual-coated radiographic element. Most of the X-radiation that participates in image formation is absorbed by phosphor particles within the fluorescent screens. This stimulates light emission that is more readily absorbed by the silver halide emulsion layers of the radiographic element.

Examples of radiographic element constructions for medical diagnostic purposes are provided by U.S. Pat. No. 4,425,425 (Abbott et al.) and U.S. Pat. No. 4,425,426 (Abbott et al.), U.S. Pat. No. 4,414,310 (Dickerson), U.S. Pat. No. 4,803,150 (Kelly et al.), U.S. Pat. No. 4,900,652 (Kelly et al.), U.S. Pat. No. 5,252,442 (Tsaur et al.), and Research Disclosure, Vol. 184, August 1979, Item 18431.

While the necessity of limiting patient exposure to high levels of X-radiation was quickly appreciated, the question of patient exposure to even low levels of X-radiation emerged gradually. The separate development of soft tissue radiography, which requires much lower levels of X-radiation, can be illustrated by mammography. The first intensifying screen-film combination (imaging assembly) for mammography was introduced to the public in the early 1970's. Mammography film generally contains a single silver halide emulsion layer and is exposed by a single intensifying screen, usually interposed between the film and the source of X-radiation. Mammography utilizes low energy X-radiation, that is radiation that is predominantly of an energy level less than 40 keV.

U.S. Pat. No. 6,033,840 (Dickerson) and U.S. Pat. No. 6,037,112 (Dickerson) describe asymmetric imaging elements and processing methods for imaging soft tissue. Imaging is carried out using a single intensifying screen.

Problem to be Solved

In mammography, as in many forms of soft tissue radiography, the pathological features that are to be identified are often quite small and not much different in density than surrounding healthy tissue. Thus, mammography is a very difficult task in medical radiography. In other to discriminate between these slight but critical differences, mammographic films must provide high contrast images. In addition, films used in mammography may require long exposure times when used to image thick, dense breast tissue. Long exposure to radiation is undesirable for a number of reasons including the danger to the patient from high radiation doses and the lack of image sharpness that results from patient movement. It would be desirable to achieve all necessary results without significant loss of other sensitometric properties.

### SUMMARY OF THE INVENTION

This invention provides a solution to the noted problems with a radiographic silver halide film comprising a support that has first and second major surfaces and that is capable of transmitting X-radiation,

the radiographic silver halide film having disposed on the first major support surface, one or more hydrophilic colloid layers including at least one silver halide emulsion layer, and on the second major support surface, one or more hydrophilic colloid layers including at least one silver halide emulsion layer,

at least one of the silver halide emulsion layers comprising cubic silver halide grains that have the same or different composition, which cubic grains are doped with a hexacoordination complex compound within part or all of the innermost 95% of the grains.

Further, this invention provides a method of providing a black-and-white image comprising exposing the radiographic silver halide film of this invention and processing it, sequentially, with a black-and-white developing composition and a fixing composition, the processing being carried out within 90 seconds, dry-to-dry.

In addition, this invention provides a radiographic imaging assembly comprising the radiographic silver halide film of this invention that is arranged in association with a fluorescent intensifying screen.

The present invention provides a means for providing mammographic images exhibiting improved image sharpness without excessive loss in speed. The invention provides a means for avoiding long exposure times of thick, dense tissues.

In addition, all other desirable sensitometric properties are maintained and the radiographic film can be rapidly processed in conventional processing equipment and compositions.

These advantages are achieved by using a hexacoordination complex compound as a dopant within the internal portions of the cubic grains in at least one of the silver halide emulsions in the film. By “internal” is meant that at least some of the innermost 95% volume of the grain is doped with the hexacoordination complex compound, and there is no dopant on the surface of the grains.

### BRIEF DESCRIPTION OF THE DRAWINGS

FIG. 1 is a schematic cross-sectional illustration of a radiographic silver halide film of this invention.

FIG. 2 is a schematic cross-sectional illustration of a radiographic imaging assembly of this invention comprising a radiographic silver halide film of this invention arranged in association with a single fluorescent intensifying screen in a cassette holder.

### DETAILED DESCRIPTION OF THE INVENTION

Definition of Terms:

The term “contrast” as herein employed indicates the average contrast derived from a characteristic curve of a radiographic film using as a first reference point (1) a density (D₁) of 0.25 above minimum density and as a second reference point (2) a density (D₂) of 2.0 above minimum density, where contrast is ΔD (i.e. 1.75)÷Δlog₁₀E (log₁₀E2−log₁₀E₁), E₁ and E₂ being the exposure levels at the reference points (1) and (2).

“Gamma” is described as the instantaneous rate of change of a D logE sensitometric curve or the instantaneous contrast at any logE value.

“Photographic speed” for the radiographic films refers to the exposure necessary to obtain a density of at least 1.0 plus Dₘᵢₙ.

“Reciprocity” refers to the photographic response of a radiographic film over an exposure range of high and low intensity of from 10⁻⁶ to 10.

The term “fully forehardened” is employed to indicate the forehardening of hydrophilic colloid layers to a level that limits the weight gain of a radiographic film to less than 120% of its original (dry) weight in the course of wet processing. The weight gain is almost entirely attributable to the ingestion of water during such processing.

The term “rapid access processing” is employed to indicate dry-to-dry processing of a radiographic film in 45 seconds or less. That is, 45 seconds or less elapse from the time a dry imagewise exposed radiographic film enters a wet processor until it emerges as a dry fully processed film.

In referring to grains and silver halide emulsions containing two or more halides, the halides are named in order of ascending molar concentrations.

The term “equivalent circular diameter” (ECD) is used to define the diameter of a circle having the same projected area as a silver halide grain.

The term “aspect ratio” is used to define the ratio of grain ECD to grain thickness.

The term “coefficient of variation” (COV) is defined as 100 times the standard deviation (a) of grain ECD divided by the mean grain ECD.

The term “covering power” is used to indicate 100 times the ratio of maximum density to developed silver measured in mg/dm².

The term “dual-coated” is used to define a radiographic film having silver halide emulsion layers disposed on both the front- and backsides of the support. The radiographic silver halide films used in the present invention are “dual-coated.”

The radiographic films of the present invention are “asymmetric” meaning that they have different emulsions on opposite sides of the support.

The term “exposure latitude” refers to the width of the gamma/logE curves for which contrast values were greater than 1.5.

The term “dynamic range” refers to the range of exposures over which useful images can be obtained (usually having a gamma greater than 2).

The term “fluorescent intensifying screen” refers to a screen that absorbs X-radiation and emits light. A “prompt” emitting fluorescent intensifying screen will emit light immediately upon exposure to radiation while “storage” fluorescent screen can “store” the exposing X-radiation for emission at a later time when the screen is irradiated with other radiation (usually visible light).

The terms “front” and “back” refer to layers, films, or fluorescent intensifying screens nearer to and farther from, respectively, the source of X-radiation.

Research Disclosure is published by Kenneth Mason Publications, Ltd., Dudley House, 12 North St., Emsworth, Hampshire P010 7DQ England. The publication is also available from Emsworth Design Inc., 147 West 24th Street, New York, N.Y. 10011.

The radiographic silver halide films of this invention include a flexible support having disposed on both sides thereof, one or more photographic silver halide emulsion layers and optionally one or more non-radiation sensitive hydrophilic layer(s). The silver halide emulsions in the various layers can be the same or different and can comprise mixtures of various silver halide emulsions within the requirements of this invention.

In preferred embodiments, the photographic silver halide film has at least one different silver halide emulsion on each side of the support. It is also preferred that the film has a protective overcoat (described below) over the silver halide emulsions on each side of the support.

The support can take the form of any conventional radiographic film support that is X-radiation and light transmissive. Useful supports for the films of this invention can be chosen from among those described in Research Disclosure, September 1996, Item 38957 XV. Supports and Research Disclosure, Vol. 184, August 1979, Item 18431, XII. Film Supports.

The support is preferably a transparent film support. In its simplest possible form the transparent film support consists of a transparent film chosen to allow direct adhesion of the hydrophilic silver halide emulsion layers or other hydrophilic layers. More commonly, the transparent film is itself hydrophobic and subbing layers are coated on the film to facilitate adhesion of the hydrophilic silver halide emulsion layers. Typically the film support is either colorless or blue tinted (tinting dye being present in one or both of the support film and the subbing layers). Referring to Research Disclosure, Item 38957, Section XV Supports, cited above, attention is directed particularly to paragraph (2) that describes subbing layers, and paragraph (7) that describes preferred polyester film supports.

Polyethylene terephthalate and polyethylene naphthalate are the preferred transparent film support materials.

In the more preferred embodiments, at least one non-light sensitive hydrophilic layer is included with the one or more silver halide emulsion layers on each side of the film support. This layer may be called an interlayer or overcoat, or both.

Preferably, the “frontside” of the support comprises one or more silver halide emulsion layers, one of which contains predominantly (more than 50 weight % of all silver halide grains) cubic grains. These cubic silver halide grains particularly generally include predominantly (at least 50 mol %) bromide, and preferably at least 70 and more preferably at least 80 mol % bromide, based on total silver in the emulsion layer. Such emulsions include silver halide grains composed of, for example, silver iodobromide, silver chlorobromide, silver iodochlorobromide, and silver chloroiodobromide. Iodide is generally limited to no more than 2 mol % (based on total silver in the emulsion layer) to facilitate more rapid processing. Preferably iodide is from about 0.25 to about 1 mol % (based on total silver in the emulsion layer). The cubic silver halide grains in each silver halide emulsion unit (or silver halide emulsion layers) can be the same or different, or include mixtures of different types of grains.

The non-cubic silver halide grains in the “frontside” emulsion layers can have any desirable morphology including, but not limited to, octahedral, tetradecahedral, rounded, spherical or other non-tabular morphologies, or be comprised of a mixture of two or more of such morphologies.

It may also be desirable to employ silver halide grains that exhibit a coefficient of variation (COV) of grain ECD of less than 20% and, preferably, less than 10%. In some embodiments, it may be desirable to employ a grain population that is as highly monodisperse as can be conveniently realized.

The average silver halide grain size can vary within each emulsion layer within the film. For example, the average cubic grain size in the radiographic silver halide film is independently and generally from about 0.7 to about 0.8 μm (preferably from about 0.72 to about 0.78 μm).

The backside of the support includes one or more silver halide emulsions, preferably at least one of which emulsions comprises tabular silver halide grains. Generally, at least 50% (and preferably at least 80%) of the silver halide grain projected area in this silver halide emulsion layer is provided by tabular grains having an average aspect ratio greater than 5, and more preferably greater than 10. The remainder of the silver halide projected area is provided by silver halide grains having one or more non-tabular morphologies. In addition, the tabular grains are predominantly (at least 90 mol %) bromide based on the total silver in the emulsion layer and include up to 1 mol % iodide. Preferably, the tabular grains are pure silver bromide.

Tabular grain emulsions that have the desired composition and sizes are described in greater detail in the following patents, the disclosures of which are incorporated herein by reference:

U.S. Pat. No. 4,414,310 (Dickerson), U.S. Pat. No. 4,425,425 (Abbott et al.), U.S. Pat. No. 4,425,426 (Abbott et al.), U.S. Pat. No. 4,439,520 (Kofron et al.), U.S. Pat. No. 4,434,226 (Wilgus et al.), U.S. Pat. No. 4,435,501 (Maskasky), U.S. Pat. No. 4,713,320 (Maskasky), U.S. Pat. No. 4,803,150 (Dickerson et al.), U.S. Pat. No. 4,900,355 (Dickerson et al.), U.S. Pat. No. 4,994,355 (Dickerson et al.), U.S. Pat. No. 4,997,750 (Dickerson et al.), U.S. Pat. No. 5,021,327 (Bunch et al.), U.S. Pat. No. 5,147,771 (Tsaur et al.), U.S. Pat. No. 5,147,772 (Tsaur et al.), U.S. Pat. No. 5,147,773 (Tsaur et al.), U.S. Pat. No. 5,171,659 (Tsaur et al.), U.S. Pat. No. 5,252,442 (Dickerson et al.), U.S. Pat. No. 5,370,977 (Zietlow), U.S. Pat. No. 5,391,469 (Dickerson), U.S. Pat. No. 5,399,470 (Dickerson et al.), U.S. Pat. No. 5,411,853 (Maskasky), U.S. Pat. No. 5,418,125 (Maskasky), U.S. Pat. No. 5,494,789 (Daubendiek et al.), U.S. Pat. No. 5,503,970 (Olm et al.), U.S. Pat. No. 5,536,632 (Wen et al.), U.S. Pat. No. 5,518,872 (King et al.), U.S. Pat. No. 5,567,580 (Fenton et al.), U.S. Pat. No. 5,573,902 (Daubendiek et al.), U.S. Pat. No. 5,576,156 (Dickerson), U.S. Pat. No. 5,576,168 (Daubendiek et al.), U.S. Pat. No. 5,576,171 (Olm et al.), and U.S. Pat. No. 5,582,965 (Deaton et al.). The patents to Abbott et al., Fenton et al., Dickerson, and Dickerson et al. are also cited and incorporated herein to show conventional radiographic film features in addition to gelatino-vehicle, high bromide (≧80 mol % bromide based on total silver) tabular grain emulsions and other features useful in the present invention.

The backside (“second major support surface”) of the radiographic silver halide film also preferably includes an antihalation layer disposed over the silver halide emulsion layer(s). This layer comprises one or more antihalation dyes or pigments dispersed on a suitable hydrophilic binder (described below). In general, such antihalation dyes or pigments are chosen to absorb whatever radiation the film is likely to be exposed to from a fluorescent intensifying screen. For example, pigments and dyes that can be used as antihalation pigments or dyes include various water-soluble, liquid crystalline, or particulate magenta or yellow filter dyes or pigments including those described for example in U.S. Pat. No. 4,803,150 (Dickerson et al.), U.S. Pat. No. 5,213,956 (Diehl et al.), U.S. Pat. No. 5,399,690 (Diehl et al.), U.S. Pat. No. 5,922,523 (Helber et al.), U.S. Pat. No. 6,214,499 (Helber et al.), and Japanese Kokai 2-123349, all of which are incorporated herein by reference for pigments and dyes useful in the practice of this invention. One useful class of particulate antihalation dyes includes nonionic polymethine dyes such as merocyanine, oxonol, hemioxonol, styryl, and arylidene dyes as described in U.S. Pat. No. 4,803,150 (noted above) that is incorporated herein for the definitions of those dyes. The magenta merocyanine and oxonol dyes are preferred and the oxonol dyes are most preferred.

The amounts of such dyes or pigments in the antihalation layer are generally from about 1 to about 2 mg/dm². A particularly useful antihalation dye is the magenta filter dye M-1 identified as follows:

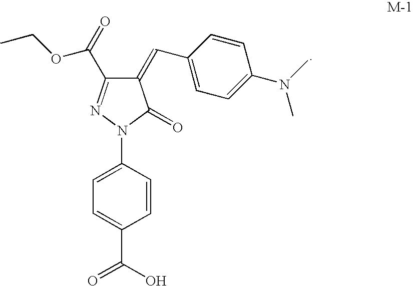

An essential feature of this invention is the presence of one or more hexacoordination complex compounds as silver halide dopants in the silver halide grains of one or more emulsions of the radiographic film. Preferably, only the cubic grains on the frontside of the film are doped with hexacoordination complex compounds. The term “dopant” is well known in photographic chemistry and generally refers to a compound that includes a metal ion that displaces silver in the crystal lattice of the silver halide grain, exhibits a positive valence of from 2 to 5, has its highest energy electron occupied molecular orbital filled and its lowest energy unoccupied molecular orbital at an energy level higher than the lowest energy conduction band of the silver halide crystal lattice forming the protrusions.

The hexacoordination complex compounds particularly useful in the practice of this invention are represented by the following Structure I:

[ML₆]ⁿ (I)

wherein M is a Group VIII polyvalent transition metal ion, L represents six coordination complex ligands that can be the same or different provided that at least four of the ligands are anionic ligands and at least one (preferably at least 3) of the ligands is more electronegative than any halide ligand, and n is −2, −3, or −4. Preferably, n is −3 or −4.

Examples of M include but are not limited to, Fe⁺², Ru⁺², Os⁺², Co⁺³, Rh⁺³, Ir⁺³, Pd⁺³, and Pt⁺⁴, and preferably M is Ru+². Examples of useful coordination complex ligands include but are not limited to, cyanide, pyrazine, chloride, iodide, bromide, oxycyanide, water, oxalate, thiocyanide, and carbon monoxide. Cyanide is a preferred coordination complex ligands.

Particularly useful dopants are ruthenium coordination complexes comprising at least 4 and more preferably 6 cyanide coordination complex ligands.

Mixtures of dopants described above can also be used.

The metal dopants can be introduced during emulsion precipitation using procedures well known in the art. They can be present in the dispersing medium present in the reaction vessel before grain nucleation. More typically, the metal coordination complexes are introduced at least in part during precipitation through one of the halide ion or silver ion jets or through a separate jet. Such procedures are described in U.S. Pat. No. 4,933,272 (McDugle et al.) and U.S. Pat. No. 5,360,712 (Olm et al.), both incorporated herein by reference, and references cited therein.

While some dopants in the art are distributed uniformly throughout 100% of the volume of the silver halide grains, it is desired in the practice of this invention to provide the dopant in only a part of the grain volume, generally within the innermost 95%, and preferably within the innermost 90%, of the volume of the grains. Methods for doing this are known in the art, for example is described in U.S. Pat. Nos. 4,933,272 and 5,360,712 (both noted above).

In other embodiments, the dopants are uniformly distributed in “bands” of the silver halide grains, for example, within a band that is from about 50 to about 80 volume % (preferably from about 75 to about 80 volume % for ruthenium hexacoordinating complex compounds) from the center or core of the grains. One skilled in the art knows how to achieve these results by planned addition of the doping compounds during only a portion of the process used to prepare the silver halide.

It is also desired that the one or more dopants be present within the cubic grains in an amount of at least 1×10⁻⁶ mole, preferably from about 1×10⁻⁶ to about 5×10⁴ mole, and more preferably from about 1×10⁻⁵ to about 5×10 4 mole, per mole of silver in the cubic grain emulsion layer.

A general summary of silver halide emulsions and their preparation is provided by Research Disclosure, Item 38957, cited above, Section I. Emulsion grains and their preparation. After precipitation and before chemical sensitization the emulsions can be washed by any convenient conventional technique using techniques disclosed by Research Disclosure, Item 38957, cited above, Section III. Emulsion washing.

Any of the emulsions can be chemically sensitized by any convenient conventional technique as illustrated by Research Disclosure, Item 38957, Section IV. Chemical Sensitization: Sulfur, selenium or gold sensitization (or any combination thereof) are specifically contemplated. Sulfur sensitization is preferred, and can be carried out using for example, thiosulfates, thiosulfonates, thiocyanates, isothiocyanates, thioethers, thioureas, cysteine, or rhodanine. A combination of gold and sulfur sensitization is most preferred.

In addition, if desired, the silver halide emulsions can include one or more suitable spectral sensitizing dyes, for example cyanine and merocyamne spectral sensitizing dyes, including the benzimidazolocarbocyanine dyes described in U.S. Pat. No. 5,210,014 (Anderson et al.), incorporated herein by reference. The useful amounts of such dyes are well known in the art but are generally within the range of from about 200 to about 1000 mg/mole of silver in the emulsion layer.

Instability that increases minimum density in negative-type emulsion coatings (that is fog) can be protected against by incorporation of stabilizers, antifoggants, antikinking agents, latent-image stabilizers and similar addenda in the emulsion and contiguous layers prior to coating. Such addenda are illustrated by Research Disclosure, Item 38957, Section VII. Antifoggants and stabilizers, and Item 18431, Section II: Emulsion Stabilizers, Antifoggants and Antikinking Agents.

It may also be desirable that one or more silver halide emulsion layers include one or more covering power enhancing compounds adsorbed to surfaces of the silver halide grains. A number of such materials are known in the art, but preferred covering power enhancing compounds contain at least one divalent sulfur atom that can take the form of a —S— or ═S moiety. Such compounds include, but are not limited to, 5-mercapotetrazoles, dithioxotriazoles, mercapto-substituted tetraazaindenes, and others described in U.S. Pat. No. 5,800,976 (Dickerson et al.) that is incorporated herein by reference for the teaching of the sulfur-containing covering power enhancing compounds.

The silver halide emulsion layers and other hydrophilic layers on both sides of the support of the radiographic films of this invention generally contain conventional polymer vehicles (peptizers and binders) that include both synthetically prepared and naturally occurring colloids or polymers. The most preferred polymer vehicles include gelatin or gelatin derivatives alone or in combination with other vehicles. Conventional gelatino-vehicles and related layer features are disclosed in Research Disclosure, Item 38957, Section II. Vehicles, vehicle extenders, vehicle-like addenda and vehicle related addenda. The emulsions themselves can contain peptizers of the type set out in Section II, paragraph A. Gelatin and hydrophilic colloid peptizers. The hydrophilic colloid peptizers are also useful as binders and hence are commonly present in much higher concentrations than required to perform the peptizing function alone. The preferred gelatin vehicles include alkali-treated gelatin, acid-treated gelatin or gelatin derivatives (such as acetylated gelatin, deionized gelatin, oxidized gelatin and phthalated gelatin). Cationic starch used as a peptizer for tabular grains is described in U.S. Pat. No. 5,620,840 (Maskasky) and U.S. Pat. No. 5,667,955 (Maskasky). Both hydrophobic and hydrophilic synthetic polymeric vehicles can be used also. Such materials include, but are not limited to, polyacrylates (including polymethacrylates), polystyrenes and polyacrylamides (including polymethacrylamides). Dextrans can also be used. Examples of such materials are described for example in U.S. Pat. No. 5,876,913 (Dickerson et al.), incorporated herein by reference.

The silver halide emulsion layers (and other hydrophilic layers) in the radiographic films are generally hardened to various degrees using one or more conventional hardeners.

Conventional hardeners can be used for this purpose, including but not limited to formaldehyde and free dialdehydes such as succinaldehyde and glutaraldehyde, blocked dialdehydes, α-diketones, active esters, sulfonate esters, active halogen compounds, s-triazines and diazines, epoxides, aziridines, active olefins having two or more active bonds, blocked active olefins, carbodiimides, isoxazolium salts unsubstituted in the 3-position, esters of 2-alkoxy-N-carboxydihydroquinoline, N-carbamoyl pyridinium salts, carbamoyl oxypyridinium salts, bis(amidino) ether salts, particularly bis(amidino) ether salts, surface-applied carboxyl-activating hardeners in combination with complex-forming salts, carbamoylonium, carbamoyl pyridinium and carbamoyl oxypyridinium salts in combination with certain aldehyde scavengers, dication ethers, hydroxylamine esters of imidic acid salts and chloroformamidinium salts, hardeners of mixed function such as halogen-substituted aldehyde acids (for example, mucochloric and mucobromic acids), onium-substituted acroleins, vinyl sulfones containing other hardening functional groups, polymeric hardeners such as dialdehyde starches, and poly(acrolein-co-methacrylic acid).

The levels of silver and polymer vehicle in the radiographic silver halide film of the present invention are not critical. In general, the total amount of silver on each side of the film is at least 10 and no more than 45 mg/dm² in one or more emulsion layers. In addition, the total coverage of polymer vehicle on each side of the film is generally at least 30 and no more than 40 mg/dm² in all of the hydrophilic layers. The amounts of silver and polymer vehicle on the two sides of the support in the radiographic silver halide film can be the same or different. These amounts refer to dry weights.

The radiographic silver halide films of this invention generally include a surface protective overcoat disposed on each side of the support that typically provides for physical protection of the emulsion layers. Each protective overcoat can be sub-divided into two or more individual layers. For example, protective overcoats can be sub-divided into surface overcoats and interlayers (between the overcoat and silver halide emulsion layers). In addition to vehicle features discussed above the protective overcoats can contain various addenda to modify the physical properties of the overcoats. Such addenda are illustrated by Research Disclosure, Item 38957, Section IX. Coating physical property modifying addenda, A. Coating aids, B. Plasticizers and lubricants, C. Antistats, and D. Matting agents. Interlayers that are typically thin hydrophilic colloid layers can be used to provide a separation between the emulsion layers and the surface overcoats. The overcoat on at least one side of the support can also include a blue toning dye or a tetraazaindene (such as 4-hydroxy-6-methyl-1,3,3a,7tetraazaindene) if desired.

The protective overcoat is generally comprised of one or more hydrophilic colloid vehicles, chosen from among the same types disclosed above in connection with the emulsion layers. Protective overcoats are provided to perform two basic functions. They provide a layer between the emulsion layers and the surface of the film for physical protection of the emulsion layer during handling and processing. Secondly, they provide a convenient location for the placement of addenda, particularly those that are intended to modify the physical properties of the radiographic film. The protective overcoats of the films of this invention can perform both these basic functions.

The various coated layers of radiographic silver halide films of this invention can also contain tinting dyes to modify the image tone to transmitted or reflected light. These dyes are not decolorized or washed out during processing and may be homogeneously or heterogeneously dispersed in the various layers. Preferably, such non-bleachable tinting dyes are in a silver halide emulsion layer.

Preferred embodiments of this invention include a silver halide film comprising a support that has first and second major surfaces and that is capable of transmitting X-radiation,

the radiographic silver halide film having disposed on the first major support surface, one or more hydrophilic colloid layers including at least one silver halide emulsion layer, and on the second major support surface, one or more hydrophilic colloid layers including at least one silver halide emulsion layer,

at least one of the silver halide emulsion layers on the first major support surface comprising cubic silver halide grains that have the same composition, which cubic grains are doped with a ruthenium hexacyanide complex compound within the innermost 75 to 80% of said cubic grains from the grain center, the ruthenium hexacyanide complex compound being present in an amount of from about 1×10⁻⁵ to about 5×10⁻⁴ mole per mole of silver in the emulsion layer,

the film further comprising a protective overcoat on both sides of the support disposed over all of the silver halide emulsion layers.

The radiographic imaging assemblies of the present invention are composed of one radiographic silver halide film of this invention and a fluorescent intensifying screen. Usually, a single fluorescent intensifying screen is used on the “frontside” for mammography. Fluorescent intensifying screens are typically designed to absorb X-rays and to emit electromagnetic radiation having a wavelength greater than 300 nm. These screens can take any convenient form providing they meet all of the usual requirements for use in radiographic imaging. Examples of conventional, useful fluorescent intensifying screens are provided by Research Disclosure, Item 18431, cited above, Section IX. X-Ray Screens/Phosphors, and U.S. Pat. No. 5,021,327 (Bunch et al.), U.S. Pat. No. 4,994,355 (Dickerson et al.), U.S. Pat. No. 4,997,750 (Dickerson et al.), and U.S. Pat. No. 5,108,881 (Dickerson et al.), the disclosures of which are here incorporated by reference. The fluorescent layer contains phosphor particles and a binder, optimally additionally containing a light scattering material, such as titania.

Any conventional or useful phosphor can be used, singly or in mixtures, in the intensifying screens used in the practice of this invention. For example, useful phosphors are described in numerous references relating to fluorescent intensifying screens, including but not limited to, Research Disclosure, Vol. 184, August 1979, Item 18431, Section IX, X-ray Screens/Phosphors, and U.S. Pat. No. 2,303,942 (Wynd et al.), U.S. Pat. No. 3,778,615 (Luckey), U.S. Pat. No. 4,032,471 (Luckey), U.S. Pat. No. 4,225,653 (Brixner et al.), U.S. Pat. No. 3,418,246 (Royce), U.S. Pat. No. 3,428,247 (Yocon), U.S. Pat. No. 3,725,704 (Buchanan et al.), U.S. Pat. No. 2,725,704 (Swindells), U.S. Pat. No. 3,617,743 (Rabatin), U.S. Pat. No. 3,974,389 (Ferri et al.), U.S. Pat. No. 3,591,516 (Rabatin), U.S. Pat. No. 3,607,770 (Rabatin), U.S. Pat. No. 3,666,676 (Rabatin), U.S. Pat. No. 3,795,814 (Rabatin), U.S. Pat. No. 4,405,691 (Yale), U.S. Pat. No. 4,311,487 (Luckey et al.), U.S. Pat. No. 4,387,141 (Patten), U.S. Pat. No. 5,021,327 (Bunch et al.), U.S. Pat. No. 4,865,944 (Roberts et al.), U.S. Pat. No. 4,994,355 (Dickerson et al.), U.S. Pat. No. 4,997,750 (Dickerson et al.), U.S. Pat. No. 5,064,729 (Zegarski), U.S. Pat. No. 5,108,881 (Dickerson et al.), U.S. Pat. No. 5,250,366 (Nakajima et al.), U.S. Pat. No. 5,871,892 (Dickerson et al.), EP-A-0 491,116 (Benzo et al.), the disclosures of all of which are incorporated herein by reference with respect to the phosphors.

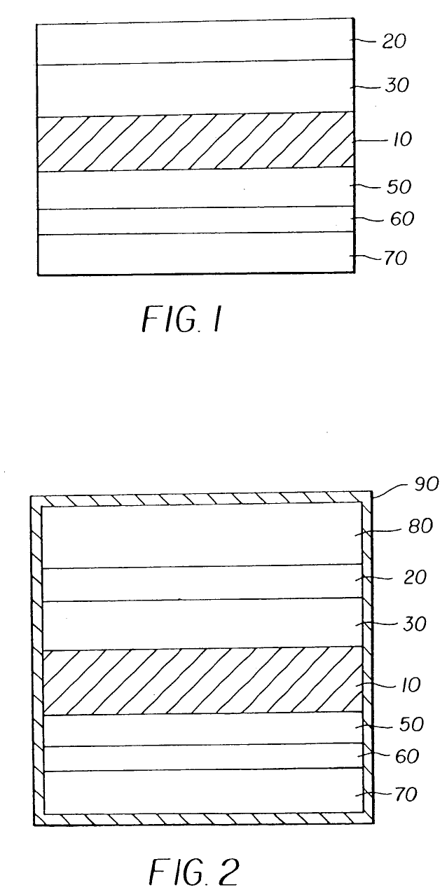

An embodiment of the radiographic film of the present invention is illustrated in FIG. 1. On the frontside of support 10 are disposed overcoat 20, and emulsion layer 30. On the backside of support 10 are disposed emulsion layer 50, antihalation layer 60, and overcoat 70.

FIG. 2 shows the radiographic film of FIG. 1 that is arranged in association with fluorescent intensifying screen 80 on the frontside, and both in cassette holder 90.

Exposure and processing of the radiographic silver halide films of this invention can be undertaken in any convenient conventional manner. The exposure and processing techniques of U.S. Pat. No. 5,021,327 and U.S. Pat. No. 5,576,156 (both noted above) are typical for processing radiographic films. Other processing compositions (both developing and fixing compositions) are described in U.S. Pat. No. 5,738,979 (Fitterman et al.), U.S. Pat. No. 5,866,309 (Fitterman et al.), U.S. Pat. No. 5,871,890 (Fitterman et al.), U.S. Pat. No. 5,935,770 (Fitterman et al.), U.S. Pat. No. 5,942,378 (Fitterman et al.), all incorporated herein by reference. The processing compositions can be supplied as single- or multi-part formulations, and in concentrated form or as more diluted working strength solutions.

Exposing X-radiation is generally directed through a single fluorescent intensifying screen before it passes through the radiographic silver halide film for imaging of soft tissue such as breast tissue.

It is particularly desirable that the radiographic silver halide films of this invention be processed within 90 seconds (“dry-to-dry”) and preferably within 60 seconds and at least 20 seconds, for the developing, fixing and any washing (or rinsing) steps. Such processing can be carried out in any suitable processing equipment including but not limited to, a Kodak X-OMAT™ RA 480 processor that can utilize Kodak Rapid Access processing chemistry. Other “rapid access processors” are described for example in U.S. Pat. No. 3,545,971 (Barnes et al.) and EP 0 248,390A1 (Akio et al.). Preferably, the black-and-white developing compositions used during processing are free of any photographic film hardeners, such as glutaraldehyde.

Radiographic kits can include a radiographic silver halide film or imaging assembly of this invention, one or more additional fluorescent intensifying screens and/or metal screens, and/or one or more suitable processing compositions (for example black-and-white developing and fixing compositions).

The following examples are presented for illustration and the invention is not to be interpreted as limited thereby.

### EXAMPLE 1

Radiographic Film A (Control):

Radiographic Film A was a single-coated film having the a silver halide emulsion on one side of a blue-tinted 170 μm transparent poly(ethylene terephthalate) film support and a pelloid layer on the opposite side. The emulsion was chemically sensitized with sulfur and gold and spectrally sensitized with the following Dye A-1.

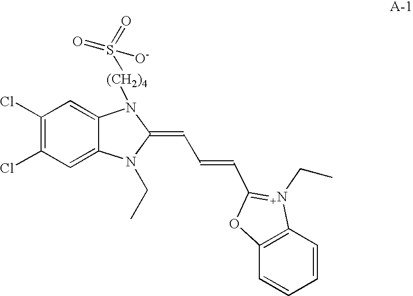

Radiographic Film A had the following layer arrangement:

Overcoat

Interlayer

Emulsion Layer

Support

Pelloid Layer

Overcoat

The noted layers were prepared from the following formulations.

| | Coverage (mg/dm²) |
|---|---|
| Overcoat Formulation | |
| Gelatin vehicle | 4.4 |
| Methyl methacrylate matte beads | 0.35 |
| Carboxymethyl casein | 0.73 |
| Colloidal silica (LUDOX AM) | 1.1 |
| Polyacrylamide | 0.85 |
| Chrome alum | 0.032 |
| Resorcinol | 0.073 |
| Dow Corning Silicone | 0.153 |
| TRITON X-200 surfactant (from Union Carbide) | 0.26 |
| LODYNE S-100 surfactant (from CIBA Specialty | 0.0097 |
| Chemicals) | |
| Interlayer Formulation | |
| Gelatin vehicle | 4.4 |
| Emulsion Layer Formulation | |
| Cubic grain emulsion | 51.1 |
| [AgBr 0.85 μm average size] | |
| Gelatin vehicle | 34.9 |
| Spectral sensitizing dye | 250 mg/Ag mole |
| 4-Hydroxy-6-methyl-1,3,3a,7- | 1 g/Ag mole |
| tetraazaindene | |
| Maleic acid hydrazide | 0.0075 |
| Catechol disulfonate | 0.42 |
| Glycerin | 0.22 |
| Potassium bromide | 0.14 |
| Resorcinol | 2.12 |
| Bisvinylsulfonylmethane | 0.4% based on total |
| | gelatin in all layers |
| | on that side |
| Pelloid Layer | |
| Gelatin | 43 |
| Dye C-1 (noted below) | 0.31 |
| Dye C-2 (noted below) | 0.11 |
| Dye C-3 (noted below) | 0.13 |
| Dye C-4 (noted below) | 0.12 |
| Bisvinylsulfonylmethane | 0.4% based on total |
| | gelatin in all layers |
| | on that side |

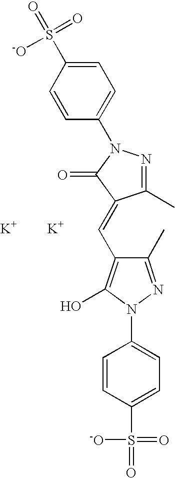

Dye C-1

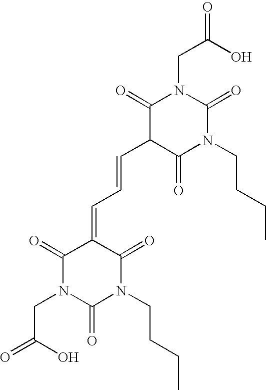

Dye C-2

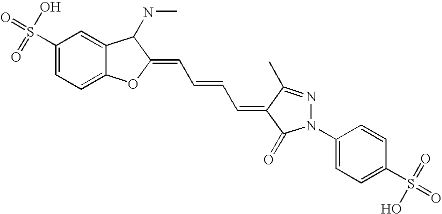

Dye C-3

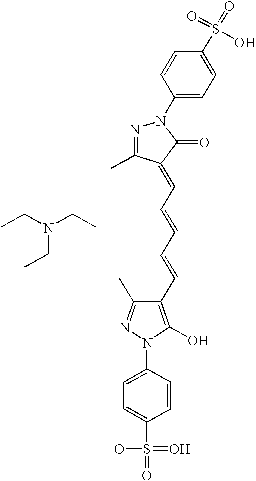

Dye C-4

Radiographic Film B (Control):

Radiographic Film B was a dual-coated radiographic film with ⅔ of the silver and gelatin coated on one side of the support and the remainder coated on the opposite side of the support. The frontside had a cubic grain emulsion spectrally sensitized with Dye A-1 noted above. On the backside was an antihalation layer containing solid particle dyes to provide improved sharpness over a green-sensitized high aspect ratio tabular grain emulsion (Emulsion Layer 2). At least 50% of the total grain projected area was accounted for by tabular grains having a thickness of less than 0.3 μm and having an average aspect ratio greater than 8:1. The emulsion was monodisperse in distribution and was spectrally sensitized with 400 mg/Ag mole of anhydro-5,5-dichloro-9-ethyl-3,3′-bis(3-sulfopropyl)oxacarbocyanine hydroxide, followed by potassium iodide (300 mg/Ag mole). Film B had the following layer arrangement and formulations on the film support:

| Overcoat 1 | |
|---|---|
| Interlayer | |
| Emulsion Layer 1 | |
| Support | |
| Emulsion Layer 2 | |
| Halation Control Layer | |
| Overcoat 2 | |
| Overcoat 1 Formulation | Coverage (mg/dm²) |
| Gelatin vehicle | 4.4 |
| Methyl methacrylate matte beads | 0.35 |
| Carboxymethyl casein | 0.73 |
| Colloidal silica (LUDOX AM) | 1.1 |
| Polyacrylamide | 0.85 |
| Chrome alum | 0.032 |
| Resorcinol | 0.73 |
| Dow Corning Silicone | 0.153 |
| TRITON X-200 surfactant | 0.26 |
| LODYNE S-100 surfactant | 0.0097 |
| Interlayer Formulation | Coverage (mg/dm²) |
| Gelatin vehicle | 4.4 |
| Emulsion Layer 1 Formulation | Coverage (mg/dm²) |
| Cubic grain emulsion | 40.3 |
| [AgBr 0.85 μm average size] | |
| Gelatin vehicle | 29.6 |
| 4-Hydroxy-6-methyl-1,3,3a,7- | 1 |
| tetraazaindene | g/Ag mole |
| 1-(3-Acetamidophenyl)-5- | 0.026 |
| mercaptotetrazole | |
| Maleic acid hydrazide | 0.0076 |
| Catechol disulfonate | 0.2 |
| Glycerin | 0.22 |
| Potassium bromide | 0.13 |
| Resorcinol | 2.12 |
| Bisvinylsulfonylmethane | 0.4% based on total |
| | gelatin in all layers on |
| | that side |
| Emulsion Layer 2 Formulation | Coverage (mg/dm²) |
| Tabular grain emulsion | 10.7 |
| [AgBr 1.8 × 0.12 μm average size] | |
| Gelatin vehicle | 16.1 |
| 4-Hydroxy-6-methyl-1,3,3a,7- | 2.1 |
| tetraazaindene | g/Ag mole |
| 1-(3-Acetamidophenyl)-5- | 0.013 |
| mercaptotetrazole | |
| Maleic acid hydrazide | 0.0032 |
| Catechol disulfonate | 0.2 |
| Glycerin | 0.11 |
| Potassium bromide | 0.06 |
| Resorcinol | 1.0 |
| Bisvinylsulfonylmethane | 2% based on total |
| | gelatin in all layers on |
| | that side |
| Halation Control Layer | Coverage (mg/dm²) |
| Magenta filter dye M-1 (noted above) | 2.2 |
| Gelatin | 10.8 |
| Overcoat 2 Formulation | Coverage (mg/dm²) |
| Gelatin vehicle | 8.8 |
| Methyl methacrylate matte beads | 0.14 |
| Carboxymethyl casein | 1.25 |
| Colloidal silica (LUDOX AM) | 2.19 |
| Polyacrylamide | 1.71 |
| Chrome alum | 0.066 |
| Resorcinol | 0.15 |
| Dow Corning Silicone | 0.16 |
| TRITON X-200 surfactant | 0.26 |
| LODYNE S-100 surfactant | 0.01 |

Radiographic Film C (Control)

Film C was like Film B except that Emulsion Layer 1 contained a AgIClBr (0.5:15:84.5 halide mole ratio) cubic grain emulsion that was chemically sensitized with sulfur an gold and spectrally sensitized with a 340 mg/mole of Ag of Dye B-1 noted above. Film C had the following layer arrangement and formulations on the film support:

| Overcoat 1 | |
|---|---|
| Interlayer | |
| Emulsion Layer 1 | |
| Support | |
| Emulsion Layer 2 | |
| Halation Control Layer | |
| Overcoat 2 | |
| Overcoat 1 Formulation | Coverage (mg/dm²) |
| Gelatin vehicle | 4.4 |
| Methyl methacrylate matte beads | 0.35 |
| Carboxymethyl casein | 0.73 |
| Colloidal silica (LUDOX AM) | 1.1 |
| Polyacrylamide | 0.85 |
| Chrome alum | 0.032 |
| Resorcinol | 0.73 |
| Dow Corning Silicone | 0.153 |
| TRITON X-200 surfactant | 0.26 |
| LODYNE S-100 surfactant | 0.0097 |
| Interlayer Formulation | Coverage (mg/dm²) |
| Gelatin vehicle | 4.4 |
| Emulsion Layer 1 Formulation | Coverage (mg/dm²) |
| Cubic grain emulsion | 40.3 |
| [AgIClBr 0.73 μm average size] | |
| Gelatin vehicle | 29.6 |
| 4-Hydroxy-6-methyl-1,3,3a,7- | 1 |
| tetraazaindene | g/Ag mole |
| 1-(3-Acetamidophenyl)-5- | 0.026 |
| mercaptotetrazole | |
| Maleic acid hydrazide | 0.0076 |
| Catechol disulfonate | 0.2 |
| Glycerin | 0.22 |
| Potassium bromide | 0.13 |
| Resorcinol | 2.12 |
| Bisvinylsulfonylmethane | 0.4% based on total |
| | gelatin in all layers on |
| | that side |
| Emulsion Layer 2 Formulation | Coverage (mg/dm²) |
| Tabular grain emulsion | 10.7 |
| [AgBr 1.8 × 0.12 μm average size] | |
| Gelatin vehicle | 16.1 |
| 4-Hydroxy-6-methyl-1,3,3a,7- | 2.1 |
| tetraazaindene | g/Ag mole |
| 1-(3-Acetamidophenyl)-5- | 0.013 |
| mercaptotetrazole | |
| Maleic acid hydrazide | 0.0032 |
| Catechol disulfonate | 0.2 |
| Glycerin | 0.11 |
| Potassium bromide | 0.06 |
| Resorcinol | 1.0 |
| Bisvinylsulfonylmethane | 2% based on total |
| | gelatin in all layers on |
| | that side |
| Halation Control Layer | Coverage (mg/dm²) |
| Magenta filter dye M-1 (noted above) | 2.2 |
| Gelatin | 10.8 |
| Overcoat 2 Formulation | Coverage (mg/dm²) |
| Gelatin vehicle | 8.8 |
| Methyl methacrylate matte beads | 0.14 |
| Carboxymethyl casein | 1.25 |
| Colloidal silica (LUDOX AM) | 2.19 |
| Polyacrylamide | 1.71 |
| Chrome alum | 0.066 |
| Resorcinol | 0.15 |
| Dow Corning Silicone | 0.16 |
| TRITON X-200 surfactant | 0.26 |
| LODYNE S-100 surfactant | 0.01 |

Radiographic Film D (Invention):

Film D was like Film C except that the cubic grains of Emulsion Layer 1 were doped with ruthenium hexacyanide at 50 mg/mole of silver.

Samples of the films were exposed through a graduated density step tablet to a MacBeth sensitometer for 0.5 second to a 500-watt General Electric DMX projector lamp that was calibrated to 2650° K filtered with a Corning C4010 filter to simulate a green-emitting X-ray screen exposure. The film samples were processed using a processor commercially available under the trademark KODAK RP X-OMAT® film Processor M6A-N, M6B, or M35A. Development was carried out using the following black-and-white developing composition:

| | | |
|---|---|---|
| Hydroquinone | 30 | g |
| Phenidone | 1.5 | g |
| Potassium hydroxide | 21 | g |
| NaHCO₃ | 7.5 | g |
| K₂SO₃ | 44.2 | g |
| Na₂S₂O₅ | 12.6 | g |
| Sodium bromide | 35 | g |
| 5-Methylbenzotriazole | 0.06 | g |
| Glutaraldehyde | 4.9 | g |
| Water to 1 liter, pH 10 | | |

The film samples were processed in each instance for less than 90 seconds. Fixing was carried out using KODAK RP X-OMAT® Fixer and Replenisher fixing composition (Eastman Kodak Company).

Optical densities are expressed below in terms of diffuse density as measured by a conventional X-rite Model 310TM densitometer that was calibrated to ANSI standard PH 2.19 and was traceable to a National Bureau of Standards calibration step tablet. The characteristic D vs. Log E curve was plotted for each radiographic film that was imaged and processed. Speed was measured at a density of 1.4+Dmin. Gamma (contrast) is the slope (derivative) of the noted curves.

“Reciprocity Failure” in TABLE I is defined in the following manner. Radiographic films are exposed as a result of attenuation of X-radiation by anatomy and absorption of the X-rays by an intensifying screen and subsequent emission of light. It is the light emitted from the screen that exposes a radiographic film. Depending on the anatomy and technique used, the exposure can vary in both intensity and time. Exposure is defined as the product of intensity times time. This definition implies that the product of intensity x time remains the same over all intensities and times. Reciprocity law failure indicates that this is not the case. Speed changes for either short or long exposure times are not always the same when compensated for by changes in intensity. In mammography, exposure times can vary by several orders of magnitude depending on breast tissue type or the exposure technique used. For example, small non-dense breast tissue can be exposed using times of as short of 1/50 second. Large dense breast tissue can be exposed using up to 2 seconds of exposure and techniques such as magnification can increase the exposure time out to as much as 10 seconds. As a result, there is a wide span of exposure times used in mammography. At the long exposure time, “low intensity reciprocity law failure” (LIRF) requires that a greater intensity exposure be used than for shorter exposure times. This results in additional X-radiation exposure for the patient. As a result, reducing the LIRF has significant benefit to the patient.

The following TABLE I shows the relative sensitometry of Films A-D. It is apparent from the data that the sensitivity of Control Films A-C are similar and provided relatively the same contrast. Film D however provided greater photographic speed, higher contrast, and significantly lower reciprocity failure than Control Films A-C. This improvement in reciprocity (a lower value is better) will result in reduced loss in sharpness from patient movement and will allow lower doses of X-radiation to be used for dense breast tissue.

TABLE I

| | Reciprocity | Relative | |
|---|---|---|---|
| Film | Failure | Speed | Contrast |
| A (Control) | 41 | 420 | 3.4 |
| B (Control) | 36 | 427 | 3.5 |
| C (Control) | 20 | 427 | 3.4 |
| D (Invention) | 10 | 433 | 4.4 |

### EXAMPLE 2

Several radiographic films like Film D were prepared with different amounts of ruthenium as the dopant in the cubic grain emulsion layer (Emulsion Layer 1). TABLE II below shows the effect of the various amounts of dopant on photographic speed, contrast and reciprocity. As the ruthenium dopant was added and increased, image contrast and the reciprocity were improved but at speed began to decrease at the highest amount of dopant.

TABLE II

| | Ruthenium | | | |
|---|---|---|---|---|
| | Compound | | | |
| Film | (mg/mole Ag) | Speed | Contrast | Reciprocity |
| C (Control) | 0 | 428 | 3.3 | 22 |
| D (Invention) | 50 | 431 | 3.7 | 16 |
| E (Invention) | 100 | 421 | 4.2 | 9 |
| F (Invention) | 200 | 379 | 4.3 | 7 |

### EXAMPLE 3

### Use of Different Dopants

A radiographic film of this invention was prepared similar to Film D (noted above) except that iron hexacyanide (31.7 mg/mole Ag) was used as the dopant in place of the ruthenium compound. This film was imagewise exposed and processed as described in Example 1. It was observed that the film provided some photographic speed and contrast improvements in the upper scale contrast range over the Control A radiographic film noted above.

The invention has been described in detail with particular reference to preferred embodiments thereof, but it will be understood that variations and modifications can be effected within the spirit and scope of the invention.

We claim:

1. A silver halide film comprising a support that has first and second major surfaces and that is capable of transmitting X-radiation,
said radiographic silver halide film having disposed on said first major support surface, one or more hydrophilic colloid layers including at least one silver halide emulsion layer, and on said second major support surface, one or more hydrophilic colloid layers including at least one silver halide emulsion layer,
at least one of said silver halide emulsion layers comprising cubic silver halide grains that have the same or different composition, which cubic grains are doped with a hexacoordination complex compound within part or all of the innermost 95% of said cubic grains.

2. The film of claim 1 wherein said doped cubic silver halide grains are composed of at least 50 mol % bromide based on total silver in the emulsion layer.

3. The film of claim 1 wherein said hexacoordination complex compound is present in an amount of at least 1×10⁻⁶ mole per mole of silver in the silver halide emulsion layer in which it is present.

4. The film of claim 3 wherein said hexacoordination complex compound is present in an amount of from about 1×10⁻⁶ to about 5×10⁻⁴ mole per mole of silver in the silver halide emulsion layer in which it is present.

5. The film of claim 1 wherein said hexacoordination complex compound is uniformly distribution within said cubic silver halide grains.

6. The film of claim 1 wherein said hexacoordination complex compound is present within the innermost 90% of the volume of said cubic silver halide grains.

7. The film of claim 1 wherein said hexacoordination complex compound is present within 75 to 80% of the innermost volume from the center of said cubic silver halide grains.

8. The film of claim 1 wherein said hexacoordination complex compound is represented by the following Structure I:
[ML₆]ⁿ (I)
wherein M is a Group 8 polyvalent transition metal ion, L represents six coordination complex ligands that can be the same or different provided that at least four of the ligands are anionic ligands and at least one of said ligands is more electronegative than any halide ligand, and n is −2, −3, or −4.

9. The film of claim 8 wherein n is −3 or −4.

10. The film of claim 8 wherein M is Fe⁺², Ru⁺², Os⁺², Co⁺³, Rh⁺³, Ir⁺³, Pd⁺³, or Pt⁺⁴.

11. The film of claim 8 wherein M is Ru⁺².

12. The film of claim 8 wherein at least three of L are cyanide ions.

13. The film of claim 1 wherein said silver halide emulsion layer on said second major support surface comprises predominantly tabular silver halide grains.

14. The film of claim 1 wherein an antihalation layer is disposed on said second major support surface.

15. The film of claim 1 further comprising a protective overcoat disposed over said hydrophilic layers on each side of said support.

16. The film of claim 1 wherein the amount polymer vehicle on each side of its support in a total amount of from about 30 to about 40 mg/dm² and a level of silver on each side of from about 10 to about 45 mg/dm².

17. A silver halide film comprising a support that has first and second major surfaces and that is capable of transmitting X-radiation,
said radiographic silver halide film having disposed on said first major support surface, one or more hydrophilic colloid layers including at least one silver halide emulsion layer, and on said second major support surface, one or more hydrophilic colloid layers including at least one silver halide emulsion layer,
at least one of said silver halide emulsion layers on said first major support surface comprising cubic silver halide grains that have the same composition, which cubic grains are doped with a ruthenium hexacyanide complex compound within the innermost 75 to 80% of said cubic grains from the grain center, said ruthenium hexacyanide complex compound being present in an amount of from about 1×10⁻⁵ to about 5×10⁻⁴ mole per mole of silver in said emulsion layer,
said film further comprising a protective overcoat on both sides of said support disposed over all of said silver halide emulsion layers.

18. A radiographic imaging assembly comprising the radiographic silver halide film of claim 1 that is arranged in association with a fluorescent intensifying screen.

19. The radiographic imaging assembly of claim 18 comprising a single fluorescent intensifying screen.

20. A method of providing a black-and-white image comprising exposing the radiographic silver halide film of claim 1 and processing it, sequentially, with a black-and-white developing composition and a fixing composition, the processing being carried out within 90 seconds, dry-to-dry.
